(19) United States
(12) Patent Application Publication
(10) Pub. No.: US 2023/0156113 A1
(43) Pub. Date: May 18, 2023

(54) METHOD AND ELECTRONIC DEVICE FOR CONTROLLING OPERATION

(71) Applicant: SAMSUNG ELECTRONICS CO., LTD., Suwon-si (KR)

(72) Inventor: Daesun RHEE, Suwon-si (KR)

(21) Appl. No.: 17/981,873

(22) Filed: Nov. 7, 2022

Related U.S. Application Data
(63) Continuation of application No. PCT/KR2022/016241, filed on Oct. 24, 2022.

(30) Foreign Application Priority Data
Nov. 12, 2021 (KR) 10-2021-0155978

(51) Int. Cl. H04M 1/72412; G06F 9/54

(52) U.S. Cl. CPC H04M 1/72412; G06F 9/54

(57) ABSTRACT

An electronic device according to various embodiments includes: a memory, a communication module comprising communication circuitry configured to communicate with an external electronic device, and a processor operatively connected to the memory and the communication module, wherein the processor is configured to: confirm that the external electronic device is in a worn state through the communication module, and transmit a control command through the communication module to change an audio output mode of the external electronic device based on an operating state of the electronic device being changed according to an instruction stored in the memory so that a designated condition is satisfied, to thereby control the operation of the external electronic device according to the designated condition.

### CROSS-REFERENCE TO RELATED APPLICATIONS

This application is a continuation of International Application No. PCT/KR2022/016241 designating the United States, filed on Oct. 24, 2022, in the Korean Intellectual Property Receiving Office and claiming priority to Korean Patent Application No. 10-2021-0155978, filed on Nov. 12, 2021, in the Korean Intellectual Property Office, the disclosures of which are incorporated by reference herein in their entireties.

### BACKGROUND

### Field

The disclosure relates to an operation control method and an electronic device thereof, for example, for controlling an operation mode of another electronic device.

### Description of Related Art

Various electronic devices, such as a smartphone, a tablet PC, a portable multimedia player (PMP), a personal digital assistant (PDA), a laptop personal computer, or a wearable device, are being widespread.

An electronic device may output sound data using a wearable electronic device such as an earphone or a headset. The electronic device may be connected to an earphone or a headset in a wireless communication method (e.g., Bluetooth), and may transmit/receive a variety of control information to output sound data to the earphone or headset.

A wireless earphone device or a wireless speaker may be inserted near the ear canal of the user's ear, or may be worn to be positioned between the outside of the user and the user's eardrum in a form that completely covers the ear, so that the user may be unable to hear an external sound while wearing the wireless earphone device or the wireless speaker.

When no external sound is introduced into the wearable electronic device such as the earphone and/or headset, the user can enjoy a higher quality sound in an immersed manner, but it may be difficult for the user to properly respond to an external situation when no external sound is introduced.

A wearable device such as an earphone and/or a headset needs to be controlled according to circumstances so that a sound can be enjoyed without an external sound being introduced or a user's response is possible when an external sound is introduced.

### SUMMARY

Embodiments of the disclosure provide an electronic device that may control a wearable electronic device so that the external sound of the wearable electronic device may or may not be introduced based on the operating state of the electronic device.

An electronic device according to various example embodiments of the disclosure may include: a memory, a communication module comprising communication circuitry configured to communicate with an external electronic device, and a processor operatively connected to the memory and the communication module, wherein the processor may be configured to: identify whether the external electronic device is in a worn state through the communication module, and transmit a control command through the communication module to change an audio output mode of the external electronic device based on an operating state of the electronic device being changed according to a command stored in the memory so that a designated condition is satisfied to thereby control an operation of the external electronic device according to the designated condition.

A method of operating an electronic device according to various example embodiments of the disclosure may include: identifying whether an external electronic device is in a worn state, identifying whether a designated condition is satisfied according to a change in an operating state of the electronic device, and transmitting a control command to change an audio output mode of the external electronic device and monitoring an operation of the external electronic device based on the designated condition being satisfied.

According to various example embodiments, it is possible to control an external sound to be introduced or not to be introduced through a wearable device such as an earphone and/or a headset based on the operating state of the electronic device, so that the user can enjoy a sound in an immersed manner by preventing and/or reducing the external sound from being introduced according to the operating state of the electronic device, or the user can appropriately respond to an external situation by allowing the external sound to be introduced.

According to various example embodiments, it is possible to configure the operating state of the electronic device for controlling an external sound to be introduced or not to be introduced through a wearable device such as an earphone and/or a headset, so that the operation of the wearable device may be controlled according to a condition configured for each user.

In addition, various effects directly or indirectly identified through this disclosure may be provided.

### BRIEF DESCRIPTION OF THE DRAWINGS

In connection with the description of the drawings, the same or similar reference numerals may be used for the same or similar components. Further, the above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a diagram illustrating an electronic device and an external electronic device (e.g., an earphone) according to various embodiments;

FIG. 3 is a block diagram illustrating an example configuration of an external electronic device according to various embodiments;

FIG. 4 is a flowchart illustrating an example operation of an electronic device for controlling an operation of an external electronic device according to various embodiments;

FIGS. 5, 6 and 7 are diagrams illustrating examples of an operation of an electronic device for controlling an operation of an external electronic device according to various embodiments;

FIG. 8 is a signal flow diagram illustrating example operations of an electronic device and an external electronic device according to various embodiments.

### DETAILED DESCRIPTION

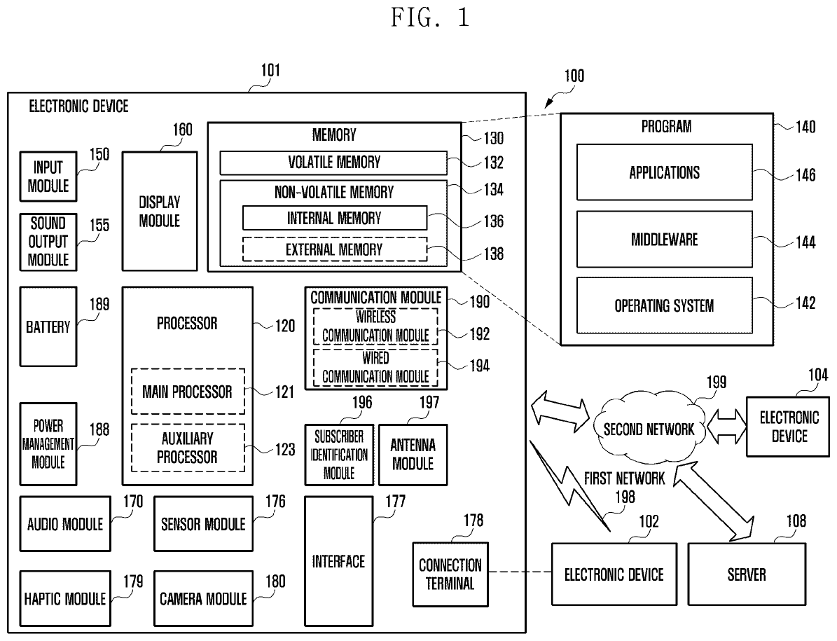

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

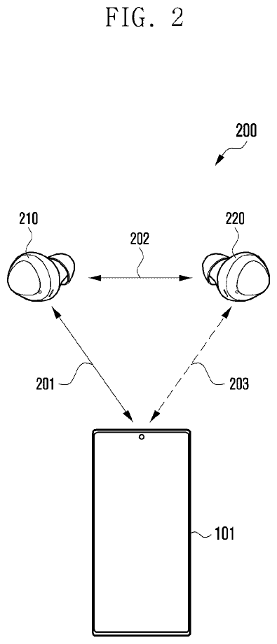

FIG. 2 is a diagram 200 illustrating an example electronic device 210 and/or 220 (e.g., the electronic device 102 of FIG. 1) and an electronic device (e.g., the electronic device 101 of FIG. 1) according to various embodiments.

Referring to FIG. 2, the electronic device 210 and/or 220 may include the first electronic device 210 and/or the second electronic device 220. For example, the electronic device 210 and/or 220 may include a headphone, an earphone, and/or an earbud capable of being worn by the user and providing a sound to the user based on audio data received from the electronic device 101 through a communication function. Hereinafter, an example in which each of the first electronic device 210 and the second electronic device 220 included in the electronic device 210 and/or 220 is implemented as an earbud will be described, but various embodiments may not be limited thereto.

According to various embodiments, the electronic device 101 may be a portable and/or movable electronic device such as a smartphone, a tablet PC, a portable multimedia player (PMP), a personal digital assistant (PDA), a laptop PC, and a wearable device.

According to various embodiments, the electronic device 101 may be an electronic device capable of reproducing music or videos, and may provide audio data corresponding thereto to the external electronic device 210 and/or 220.

According to various embodiments, the electronic device 210 and/or 220 may be connected to the electronic device 101 by wireless communication. For example, the electronic device 101 may communicate with the first electronic device 210 using a first communication link 201 (e.g., the first network 198 of FIG. 1) including a local area communication network such as Bluetooth (or BLE), Wi-Fi direct, or infrared data association (IrDA). Hereinafter, an example in which the electronic device 101 communicates with the first electronic device 210 through the first communication link 201 will be described, but various embodiments are not limited thereto. The electronic device 101 may communicate with the second electronic device 220 through a separate communication link 203 or may communicate with the first electronic device 210 and/or the second electronic device 220 through each independent communication link.

According to various embodiments, the first electronic device 210 and the second electronic device 220 may communicate with each other through a second communication link 202 using a local area communication network such as Bluetooth (or BLE), Wi-Fi direct, or infrared data association (IrDA).

According to an embodiment, one (e.g., the first electronic device 210) of the external electronic devices 210 and/or 220 may serve as a primary to communicate with the electronic device 101, and the other (e.g., the second electronic device 220) of the external electronic devices 210 and/or 220 may serve as a secondary to communicate with the first electronic device 210 which is the primary electronic device. In an embodiment, when each of the first electronic device 210 and the second electronic device 220 is implemented as an earbud, the first electronic device 210 may be referred to as a primary earbud or primary equipment (PE), and the second electronic device 220 may be referred to as a secondary earbud or secondary equipment (SE). For example, the first electronic device 210 may communicate with the electronic device 101 through the first communication link 201 as the primary, and the second electronic device 220 may communicate with the first electronic device 220 through the second communication link 202 as the secondary. In this case, a third communication link 203 between the second electronic device 220 and the electronic device 101 may be in an idle state and/or in an unconnected state. For example, as the secondary electronic device, the second electronic device 220 may sniff the first communication link 201 between the first electronic device 210 and the electronic device 101 to acquire data transmitted from the electronic device 101 to the first electronic device 210.

Hereinafter, a case in which the first electronic device 210 among the external electronic devices 210 and/or 220 is communicably connected to the electronic device 101 through the first communication link 201 as the primary electronic device in the initial operation to transmit/receive data and the second electronic device 220 sniffs the first communication link 201 as the secondary to acquire data will be described as an example. In this case, the third communication link 203 with the electronic device 101 may be in an idle state and/or in an unconnected state.

According to an embodiment, the first electronic device 210 as the primary may allow the second electronic device 220 to operate as the primary to be communicably connected to the electronic device 101 through the third communication link 203 by a role switch with the second electronic device 220 as the secondary. For example, the first electronic device 210 may switch its role to the secondary (slave) to communicate with the primary second electronic device 220 through the second communication link 202, and may acquire data transmitted from the electronic device 101 to the second electronic device 220 through sniffing on the third communication link 203. For example, the second electronic device 210 that has switched its role to the secondary may switch the first communication link 201 with the electronic device 101 into an idle state and/or a non-connected state.

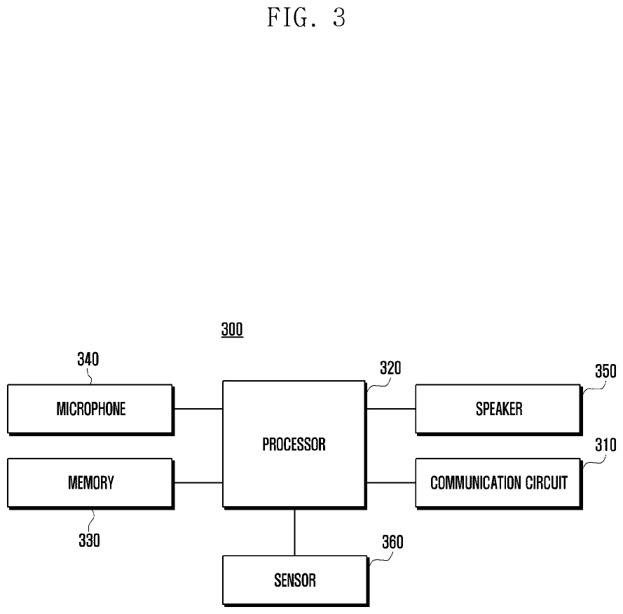

FIG. 3 is a block diagram illustrating an example configuration of an electronic device 300 (e.g., the first electronic device 210 or the second electronic device 220 of FIG. 2) according to various embodiments.

Referring to FIG. 3, the electronic device 300 may include a communication circuit 310, a processor (e.g., including processing circuitry) 320, a memory 330, a microphone 340, a speaker 350, and/or a sensor 360. The components included in FIG. 3 are some of the components included in the electronic device 300, and the electronic device 300 may further include various other components (e.g., a power management circuit and/or a battery).

The processor 320 may include various processing circuitry and execute, for example, software (e.g., a program) to process a control command and/or audio data received from an electronic device (e.g., the electronic device 101 of FIG. 2) connected through the communication circuit 310, and may store information according to the processing result or information generated according to the operation of various components in the memory 330 or transmit the information to other electronic devices (e.g., the electronic device 101, the first electronic device 210, and/or the second electronic device 220). To this end, the processor 320 may control at least one other component (e.g., hardware or software component) of the electronic device 300 and may process or operate a variety of data.

The memory 330 may store a variety of data used by at least one component (e.g., the processor 320 or the sensor 360) of the electronic device 300. The data may include, for example, input data or output data for software (e.g., a program) and commands related thereto. The memory 330 may include a volatile memory or a nonvolatile memory.

According to an embodiment, as at least a part of data processing or operation, the processor 320 may load commands or data received from another component (e.g., the sensor 360 or the communication circuit 310) into the volatile memory, may process the commands or data loaded into the volatile memory, and may store the resultant data in the nonvolatile memory.

The communication circuit 310 may support establishment of a communication channel through a communication link (e.g., the first communication link 201, the second communication link 202, or the third communication link 203) between the electronic device 300 and the electronic device 101 or between the electronic device 300 and another electronic device (e.g., the second electronic device 220 or the first electronic device 210), and/or may support communication performance through the established communication channel.

According to an embodiment, the communication circuit 310 may include a wireless communication module (e.g., a cellular communication module, a local area wireless communication module, or a global navigation satellite system {GNSS} communication module) or a wired communication module.

According to an embodiment, the communication circuit 310 may communicate with the electronic device 101 through the first communication link 201 and the third communication link 203 (e.g., a local area wireless communication network such as Bluetooth, Wi-Fi direct, or infrared data association {IrDA}).

According to an embodiment, the communication circuit 310 may communicate with another electronic device (e.g., the second electronic device 220) through the second communication link 202 (e.g., a local area wireless communication network such as Bluetooth, Wi-Fi direct, or infrared data association {IrDA}).

According to an embodiment, the communication circuit 310 may include an antenna module. The antenna module of the communication circuit 310 may transmit or receive a signal and/or power to or from the outside (e.g., the electronic device 101). According to an embodiment, the antenna module of the communication circuit 310 may include one antenna including a radiator including a conductor or a conductive pattern provided on a substrate (e.g., a PCB).

According to an embodiment, the antenna module may include a plurality of antennas. In this case, among the plurality of antennas, at least one antenna suitable for a communication scheme used in a wireless communication network such as the first communication link 301, the second communication link 302, and/or the third communication link 303 may be selected by the communication circuit 310. The signal or power may be transmitted or received between the communication circuit 310 and an external electronic device (e.g., the sound source electronic device 101) through the selected at least one antenna. According to various embodiments, another component (e.g., an RFIC) other than the radiator may be additionally provided as a portion of the antenna module.

According to an embodiment, the sensor 360 may include a contact or grip sensor, an acceleration sensor, and/or a gyro sensor, but is not limited thereto. The contact or grip sensor may detect, when the electronic device 300 is brought into a contact with, for example, the user's ear for a designated time period or more and/or a designated intensity or more, this contact, and may transmit a sensor signal to the processor 320. The acceleration sensor and/or the gyro sensor may detect motion and/or inertia of the electronic device 300. The acceleration sensor and/or the gyro sensor may include a circuit (e.g., an integrated circuit {IC}) for controlling the operation of the acceleration sensor and/or the gyro sensor. For example, the circuit (e.g., an integrated circuit {IC}) for controlling the operation of the acceleration sensor and/or the gyro sensor may be included in the electronic device 300 and may be implemented as the processor 320.

According to an embodiment, the processor 320 may determine whether the electronic device 300 is worn based on a sensor value obtained from the contact or grip sensor, the acceleration sensor, and/or the gyro sensor of the sensor 360, and may transmit, to the electronic device 101, a signal indicating that the electronic device is worn when it is determined that the electronic device 300 is worn.

According to an embodiment, the speaker 350 may output an audio signal to the outside of the electronic device 300. The processor 320 may output an electrical signal (audio signal) processed based on the audio data received from the wirelessly connected electronic device 101 as a sound through the speaker 350.

The microphone 340 may convert a sound obtained from the outside into an electrical signal. The sound introduced into the microphone 340 may include, for example, the sound of the speaker 350 reflected from the inside of the user's external auditory meatus in addition to the sound generated in the user's external environment when the electronic device 300 is worn.

According to an embodiment, the processor 320 may mix and output the sound acquired from the microphone 340 and the audio data received from the electronic device 101 according to the audio output mode of the electronic device 300. For example, when the audio output mode is an ambient sound canceling mode, the processor 320 may mute the sound acquired from the microphone 340 and may output only an audio signal converted from the audio data through the speaker 350. For example, when the audio output mode is the ambient sound listening mode, the processor 320 may mix the sound acquired from the microphone 340 and the audio signal converted from the audio data, and may output the mixed data through the speaker 350. The processor 320 may change or maintain the audio output mode to the ambient sound canceling mode or the ambient sound listening mode based on an audio mode control command received from the electronic device 101 through the communication circuit 310. As another example, the processor 320 may transmit information according to the processing result of the control command received from the electronic device 101 to the electronic device 101.

Although not illustrated, the electronic device 300 may include a battery for supplying power required for each component. The electronic device 300 may further include a power management circuit (not illustrated) for controlling charging of the battery using power supplied from an external power source and managing power supplied to each component. The battery may include, for example, a non-rechargeable primary cell, a rechargeable secondary cell, and/or fuel cell.

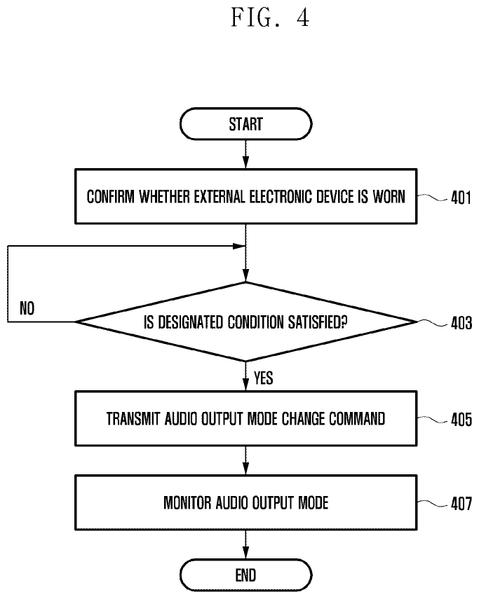

FIG. 4 is a flowchart illustrating an example operation of an electronic device (e.g., the electronic device 101 of FIG. 1 or 2) for controlling an operation of an external electronic device (e.g., the electronic device 300 of FIG. 3) according to various embodiments.

According to an embodiment, the external electronic device 300 may include a headphone, an earphone, and/or an earbud, or the like, which can be worn on the user and provide a sound to the user based on audio data received from the electronic device 101 through a communication function. Hereinafter, an example in which the external electronic device 300 is implemented as a wearable electronic device such as an earbud will be described, but various embodiments may not be limited thereto.

According to various embodiments, the electronic device 101 may include a portable and/or movable electronic device such as a smartphone, a tablet PC, a portable multimedia player (PMP), a personal digital assistant (PDA), a laptop PC, and a wearable device.

According to various embodiments, the electronic device 101 may be an electronic device capable of reproducing music or videos, and accordingly, may provide audio data processed by an audio module (e.g., the audio module 170 of FIG. 1) to the external electronic device 300.

According to various embodiments, the electronic device 101 may be connected to the external electronic device 300 using a local area wireless communication network such as Bluetooth (or BLE), Wi-Fi direct, or infrared data association (IrDA) to transmit audio data or a variety of control information including a control command. The electronic device 101 may receive information on confirmation of reception and processing results and/or information on the operating state from the external electronic device 300.

According to an embodiment, in operation 401, a processor (e.g., the processor 120 of FIG. 1) of the electronic device 101 may confirm whether the external electronic device 300 is in a worn state.

According to an embodiment, the processor 120 may be connected to the external electronic device 300 through the communication module 190 to receive a signal for confirming whether the external electronic device 300 is in a worn state from the external electronic device 300. For example, the processor 120 may receive, from the external electronic device 300, related information for confirming whether the external electronic device 300 is in a worn state based on a sensor signal of a sensor (e.g., the sensor 360 of FIG. 3) of the external electronic device 300. For example, the processor 320 of the external electronic device 300 may establish a connection with the electronic device 101 through a wireless communication network as the external electronic device 300 is activated, and may transmit, to the electronic device 101, information indicating that the external electronic device 300 is worn based on the sensor signal received through the sensor 360 as the external electronic device 300 is worn on the user.

According to an embodiment, the processor 120 of the electronic device 101 may be connected to the external electronic device 300 through a communication module (e.g., the communication module 190 of FIG. 1) by instructions stored in a memory (e.g., the memory 130 of FIG. 1), for example, using local area wireless communication such as Bluetooth. When allocating communication resources in communication with the external electronic device 300 through the communication module 300 using local area wireless communication such as Bluetooth, the processor 120 may relatively assign a processing priority to a control command for switching an audio output mode. For example, in allocating communication resources, the processor 120 may relatively assign a priority to the control command for switching the audio output mode compared to the audio data. Accordingly, the control command for switching the audio output mode may be transmitted to the external electronic device 300 without delay. Meanwhile, when the communication resource is allocated, the processor 120 may allow the audio data to be streamed without delay by assigning a relatively lower priority to control information excluding the control command for switching the audio output mode, compared to the audio data.

According to an embodiment, in operation 403, the processor 120 of the electronic device 101 may monitor the operating state of the electronic device 101 when the external electronic device 300 is in a worn state to determine whether a designated condition is satisfied.

According to an embodiment, the processor 120 of the electronic device 101 may store information on a designated condition for the operating state of the electronic device 101 in a memory (e.g., the memory 130 of FIG. 1), and may monitor the operating state of the electronic device 101 to determine whether the designated condition is satisfied.

According to an embodiment, the designated condition for the operating state of the electronic device 101 may include information indicating whether at least one application and/or component is activated or operated. For example, the designated condition may include a case in which at least one application and/or component in which a user's utterance can be expected or a user's response according to the user's recognition is requested is activated and operated. For example, the designated condition may include activation of a near field communication (NFC) tag and/or a magnetic secure transmission (MST) tag application in which tagging and confirmation thereof are required. For example, the designated condition may include a case in which an application for simple payment authentication that requires user's fingerprint recognition and/or password authentication is activated. For example, the designated condition may include a case in which a recording application requiring user's recognition or response and/or a photographing application are executed.

For example, the designated condition may include a case in which the activation of at least one application and/or component in which a user's utterance can be expected or a user's recognition is requested or a user's response is required as described above is terminated and the operation is terminated.

According to an embodiment, the designated condition may be configured in advance in the electronic device 101 or may be configured by the user. For example, the processor 120 of the electronic device 101 may display a screen for configuring a condition for changing an operation mode of the external electronic device 300 on a display (e.g., the display module 160 of FIG. 1) according to a user input, which will be described later in detail.

According to an embodiment, when the designated condition is satisfied, in operation 405, the processor 120 may transmit a control command requesting a change in the audio output mode for the external electronic device 300 to the external electronic device 300.

According to an embodiment, the audio output mode of the external electronic device may include an ambient noise canceling mode to which, for example, active noise cancellation (ANC) technology is applied, and/or an ambient sound listening mode in which the ANC technology is not applied or an external sound introduced through the microphone (e.g., the microphone 340 of FIG. 3) of the external electronic device 300 is output through the speaker 350. The name used for the ambient sound canceling mode or the ambient sound listening mode is merely an example. The ambient sound canceling mode may include an operation mode in which various technologies are applied to increase the immersion in the audio signal output by blocking sounds introduced from the outside except for the audio signal generated by the audio data, and the ambient sound listening mode may include an operation mode that does not block the sounds introduced from the outside and may further include an operation mode in which the sound introduced from the outside is output through the speaker 350 at least a certain volume or more together with the audio signal. For example, in a case in which an activation condition of at least one application and/or component in which a user's utterance can be expected in the electronic device 101, a user's recognition is requested, or a user's response is required is satisfied, an audio output mode change command for changing the ambient sound canceling mode to the ambient sound listening mode may be transmitted to the external electronic device 300.

According to an embodiment, according to the audio output mode change command transmitted from the electronic device 101, the external electronic device 300 may change the audio output mode from the ambient sound canceling mode to the ambient sound listening mode or from the ambient sound listening mode to the ambient sound canceling mode. For example, in the case in which an activation condition of at least one application and/or component in which a user's utterance can be expected in the electronic device 101, a user's recognition is requested, or a user's response is required is satisfied, as the audio output mode change command for changing the ambient sound canceling mode to the ambient sound listening mode is transmitted from the electronic device 101 to the external electronic device 300, the audio output mode of the external electronic device 300 may be changed to the ambient sound listening mode correspondingly. For example, in a case in which an activation termination condition of at least one application and/or component in which a user's utterance can be expected in the electronic device 101, a user's recognition is requested, or a user's response is required is satisfied, as the audio output mode change command for changing the ambient sound listening mode to the ambient sound canceling mode is transmitted from the electronic device 101 to the external electronic device 300, the audio output mode of the external electronic device 300 may be changed to the ambient sound canceling mode accordingly.

According to an embodiment, the external electronic device 300 may change the audio output mode from the ambient sound listening mode to the ambient sound canceling mode according to a user input. For example, when a touch input (e.g., a long touch or a double touch) to the external electronic device 300 is generated, the audio output mode may be changed from the current mode to another mode. For example, when the touch input to the external electronic device 300 is generated, the audio output mode may be changed from the ambient sound listening mode to the ambient sound canceling mode. As another example, after the audio output mode for the external electronic device 300 is changed to the ambient sound canceling mode, when a touch input is generated again, the audio output mode may be changed from the ambient sound canceling mode to the ambient sound listening mode.

According to an embodiment, the electronic device 300 may mix the sound acquired from the microphone 340 with the audio data received from the electronic device 101 according to the audio output mode, or may mute or output the sound acquired from the microphone 340. For example, when the audio output mode is the ambient sound canceling mode, the processor 320 may reverse the phase of wave with respect to the sound acquired from the microphone 340 and may output the resultant data through the speaker 350, thereby causing destructive interference with respect to the sound acquired from the microphone 340 to block ambient sounds and allowing the user to focus on the audio signal. For example, when the audio output mode is the ambient sound listening mode, the electronic device 300 may mix the sound acquired from the microphone 340 and the audio signal converted from the audio data, and may output the mixed data through the speaker 350.

According to an embodiment, the electronic device 300 may store the currently operating audio output mode in the memory 330 according to the change in the audio output mode.

According to an embodiment, in operation 407, the processor 120 of the electronic device 101 may monitor the audio output mode of the external electronic device 300.

According to an embodiment, the processor 120 of the electronic device 101 may transmit/receive a variety of information through communication with the external electronic device 300, and may receive information on the processing result according to a change command of the operation mode from the external electronic device 300. For example, the processor 120 may receive information indicating that the audio output mode has been changed according to the command change of the audio output mode to the external electronic device 300. For example, the processor 120 may receive information indicating that the audio output mode changed according to the audio output mode change command of the external electronic device 300 is operating.

According to an embodiment, the external electronic device 300 may detect a user's voice utterance using an acceleration sensor and/or the microphone 340 of a sensor (e.g., the sensor 360 of FIG. 3), and may operate to change the audio output mode to the ambient sound listening mode or maintain the ambient sound listening mode when the voice utterance is detected. When the audio output mode is changed, the external electronic device 300 may notify the electronic device 101 of the mode change.

According to an embodiment, the external electronic device 300 may be implemented to operate a timer at a time point when the audio output mode is changed to the ambient sound listening mode according to the control of the electronic device 101 and/or at a time point when it is determined that the audio output mode is changed to the ambient sound listening mode or the audio output mode is maintained according to a user's utterance, and to maintain the ambient sound listening mode for a designated time. For example, the timer for maintaining the ambient sound listening mode may be configured as time required to maintain the activation of the at least one application and/or component in which a user's utterance can be expected, a user's recognition is requested, or a user's response is required.

According to an embodiment, when the external electronic device 300 terminates the ambient sound listening mode according to the expiration of the timer, the external electronic device 300 may notify the electronic device 101 of the termination of the ambient sound listening mode. Accordingly, the electronic device 101 may confirm that the above-described condition is satisfied and confirm the termination of the ambient sound listening mode of the external electronic device 300, or may transmit a control command for maintaining the ambient sound listening mode to the external electronic device 300.

According to an embodiment, the processor 120 may transmit a request for identifying the current operation mode or operating state of the external electronic device 300 periodically or if necessary, and may receive a response thereto from the external electronic device 300.

According to an embodiment, the processor 120 may display information on a change in the operation mode and/or the current operation mode of the external electronic device 300 on a display (e.g., the display module 160 of FIG. 1).

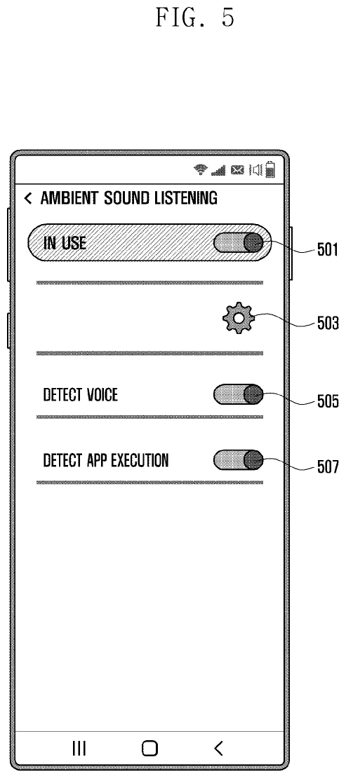

FIGS. 5, 6 and 7 are diagrams illustrating examples of an operation of an electronic device (e.g., the electronic device 101 of FIG. 1) for controlling an operation of an external electronic device (e.g., the electronic device 300 of FIG. 3) according to various embodiments.

FIG. 5 illustrates an example of a screen of a display for configuring an operating state condition of the electronic device 101 for changing a current operation mode to an ambient sound listening mode for the external electronic device 300 according to a setting function.

An ambient sound listening mode setting screen of FIG. 5 may provide a selection button 501 for enabling or disabling an ambient sound listening mode function.

According to an embodiment, the ambient sound listening mode setting screen may provide a voice detection selection button 505 for enabling the ambient sound listening mode to be activated as the user's utterance is detected when the ambient sound listening mode is used. In a case of using the ambient sound listening mode, the electronic device 101 may control the audio output mode of the external electronic device 300 to be changed to the ambient sound listening mode when the user's utterance is detected.

According to an embodiment, when the ambient sound listening mode is used, as a designated application is activated, the ambient sound listening mode setting screen may provide an app execution detection selection button 507 to activate the ambient sound listening mode. According to this, in a case in which the ambient sound listening mode is used, the electronic device 101 may control the audio output mode of the external electronic device 300 to be changed to the ambient sound listening mode when the execution of one of the designated applications is detected.

According to an embodiment, the ambient sound listening mode setting screen may include a detailed setting button 503 for providing a more detailed configuration menu.

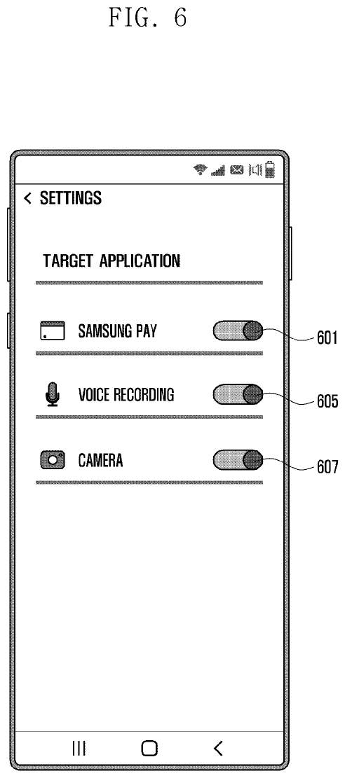

FIG. 6 illustrates a detailed setting screen for an ambient sound listening mode target application provided according to the selection of the detailed setting button 503 of FIG. 5.

Referring to FIG. 6, the detailed setting screen may provide a list of selectable applications so that the external electronic device 300 changes the audio output mode to the ambient sound listening mode when an application configured for various applications is executed. For example, the detailed setting screen may provide a selection button 601 for a payment application (e.g., Samsung Pay app), a selection button 605 for a recording application (e.g., a voice recording app), and/or a selection button 607 for an image taking application (e.g., a camera app). As an example, the displayed application may be provided through the detailed setting screen so that various applications capable of being executed in the electronic device 101 can be included in a condition for changing the audio output mode of the external electronic device 300 to the ambient sound listening mode.

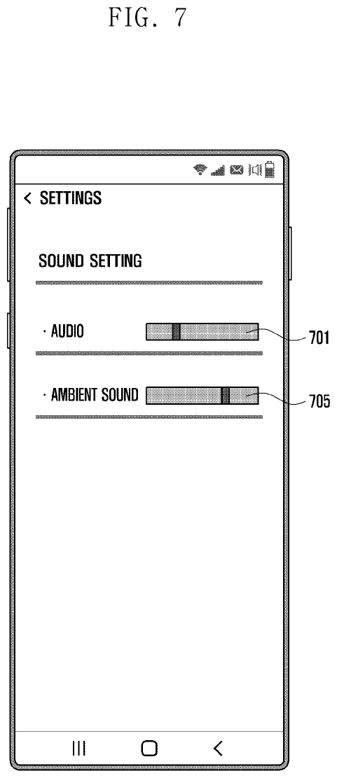

In FIG. 7, a setting screen for configuring the volume of audio data and ambient sound may be displayed in the ambient sound listening mode provided according to the selection of the detailed setting button 503 of FIG. 5.

Referring to FIG. 7, a volume setting screen may provide a sound bar 701 for configuring the volume of an audio signal and a sound bar 705 for configuring the volume of an ambient sound. For example, when the volume is not configured separately, the external electronic device 300 may mix an audio signal and an ambient sound signal and may output the mixed signal through a speaker (e.g., the speaker 350 of FIG. 3) so that the audio volume and ambient sound volume are configured to be heard at a level of 50:50 by default. For example, when the volume is configured to a volume of 30 for the audio volume sound bar 701 and a volume of 70 for the sound bar 705 of the ambient sound volume, the audio signal and the ambient sound signal may be mixed and output the mixed signal through the speaker 350 so that the audio volume and the ambient sound volume are configured to be heard at a level of 30:70 according to the settings.

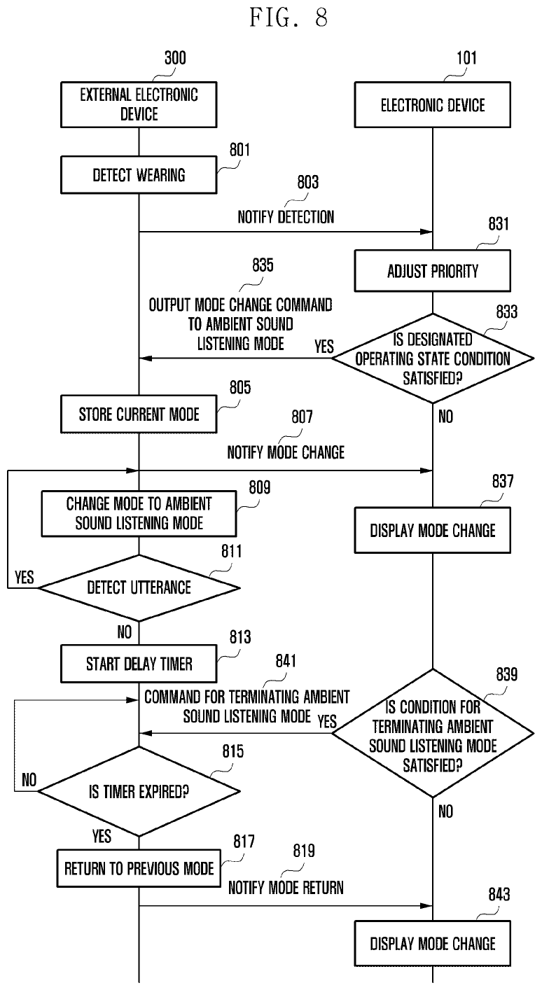

FIG. 8 is a signal flow diagram illustrating an example operation of an electronic device (e.g., the electronic device 101 of FIG. 1 or 2) for controlling the operation of an external electronic device (e.g., the external electronic device 210 or 220 of FIG. 2 or the external electronic device 300 of FIG. 3) according to various embodiments.

According to an embodiment, the external electronic device 300 may include a headphone, an earphone, and/or an earbud, or the like, capable of being worn on the user and providing a sound to the user based on audio data received from the electronic device 101 through a communication function. Hereinafter, an example in which the external electronic device 300 is implemented as a wearable electronic device such as an earbud will be described, but various embodiments may not be limited thereto.

According to various embodiments, the electronic device 101 may include, for example, and without limitation, a portable and/or movable electronic device such as a smartphone, a tablet PC, a portable multimedia player (PMP), a personal digital assistant (PDA), a laptop PC, a wearable device, or the like.

According to various embodiments, the electronic device 101 may be an electronic device capable of reproducing music or videos, and accordingly, may provide audio data processed by an audio module (e.g., the audio module 170 of FIG. 1) to the external electronic device 300.

According to various embodiments, the electronic device 101 may be connected to the external electronic device 300 using a local area wireless communication network such as Bluetooth (or BLE), Wi-Fi direct, or infrared data association (IrDA) to transmit audio data or a variety of control information including a control command. The electronic device 101 may receive information on confirmation of reception and processing results and/or information on the operating state from the external electronic device 300.

According to an embodiment, in operation 801, the external electronic device 300 may detect the wearing of the external electronic device 300. For example, the external electronic device 300 may detect whether the external electronic device 300 is worn on the user's ear based on a sensor signal of a sensor (e.g., the sensor 360 of FIG. 3) including a proximity sensor, a grip sensor, and/or an acceleration sensor.

According to an embodiment, in operation 803, the external electronic device 300 may notify the electronic device 101 of detection of the wearing of the external electronic device 300. For example, as the external electronic device 300 is activated, the external electronic device 300 may establish a connection with the electronic device 101 through a wireless communication network, and may transmit, to the electronic device 101, information indicating that the external electronic device 300 is worn based on the sensor signal received through the sensor 360 as the external electronic device 300 is worn on the user.

According to an embodiment, the electronic device 101 may be connected to the external electronic device 300 through a communication module (e.g., the communication module 190 of FIG. 1), and may receive the wearing detection signal from the external electronic device 300.

According to an embodiment, in operation 831, the electronic device 101 may adjust a priority for communication resource allocation in wireless communication in order to give a priority to a control command for a mode change for the external electronic device 300. For example, the electronic device 101 may be connected to the external electronic device 300 through a communication module using local area wireless communication such as Bluetooth communication, and may assign a processing priority for the control command for switching the audio output mode when allocating the communication resource in communication with the external electronic device 300 through the communication module 190. For example, in allocating communication resources, the electronic device 101 may relatively assign a priority to the control command for switching the audio output mode in allocating the communication resources, compared to the audio data. Accordingly, the control command for switching the audio output mode may be transmitted to the external electronic device 300 without delay. Meanwhile, when the communication resource is allocated, the electronic device 101 may allow the audio data to be streamed without delay by assigning a relatively lower priority to control information excluding the control command for switching the audio output mode, compared to the audio data.

In general, when the external electronic device 300 to which active noise cancellation (ANC) technology is applied is worn, it may be difficult to hear an ambient sound because the ambient sound is shielded. Accordingly, when a wearer's utterance is detected using a microphone or a vibration sensor, a function of switching to the ambient sound listening mode may be provided. However, even in this case, since the ambient sound listening mode is activated only when the wearer speaks, ambient sounds such as words from the other party or warning sounds from the surroundings are shielded before the wearer speaks and the wearer cannot hear the ambient sounds, so that it may be difficult to determine the corresponding situation. For example, the user may not be able to hear the ambient sound at the time of the other party's conversation during simple payment, a tapping sound when using a transportation card, or in a situation where photographing or recording is taking place.

According to an embodiment, in operation 833, when the external electronic device 300 is in a worn state, the operating state of the electronic device 101 may be monitored to determine whether a designated condition for entering the ambient sound listening mode is satisfied.

According to an embodiment, the electronic device 101 may identify information on the designated condition for entering the ambient sound listening mode for the operating state of the electronic device 101 from a memory (e.g., the memory 130 of FIG. 1), and may determine whether the condition is satisfied by monitoring the operating state of the electronic device 101 based on the identified information.

According to an embodiment, the designated condition for the operating state of the electronic device 101 may include various cases in which the activation condition of at least one application and/or component in which a wearer's utterance of the external electronic device 300 can be expected in the electronic device 101, a wearer's recognition is requested, or a wearer's response is required is satisfied. For example, the designated condition may include activation of a near field communication (NFC) tag and/or a magnetic secure transmission (MST) tag application for which tagging and confirmation thereof are required. For example, the designated condition may include a case in which an application for simple payment authentication that requires user's fingerprint recognition and/or password authentication is activated. For example, the designated condition may include a case in which a recording application and/or a photographing application requiring user's recognition or response are executed.

According to an embodiment, according to the designated condition for the operating state of the electronic device 101 for entering the ambient sound listening mode, even before the wearer's utterance of the external electronic device 300, by responding in advance to situations in which it is necessary or expected to listen to ambient sounds, the wearer may listen to the ambient sounds and determine the situation.

According to an embodiment, in operation 835, when the designated condition is satisfied, the electronic device 101 may transmit a control command for allowing an audio output mode for the external electronic device 300 to be changed to an ambient sound listening mode, to the external electronic device 300.

According to an embodiment, the ambient sound listening mode of the external electronic device 300 may include an operation mode in which sounds introduced from the outside are not blocked and further include an operation in which the sounds introduced from the outside are output through the speaker 350 at least a predetermined volume or higher together with an audio signal.

According to an embodiment, in operation 805, according to an audio output mode change command transmitted from the electronic device 101, the external electronic device 300 may store the current audio output mode. For example, when the current audio output mode is the ambient sound canceling mode, the fact that the ambient sound canceling mode is operating may be stored, and the electronic device may return to the ambient sound canceling mode, which is the current audio output mode, when a situation required to return to the ambient sound canceling mode occurs.

According to an embodiment, in operation 807, the external electronic device 300 may notify the electronic device 101 of a change in the audio output mode of the external electronic device 300. For example, the external electronic device 300 may notify the electronic device 101 that the audio output mode is changed to the ambient sound listening mode as a result of processing the audio output mode change command of the electronic device 101.

According to an embodiment, in operation 837, the electronic device 101 may display, for example, a change in the audio output mode of the external electronic device 300 on a display (e.g., the display module 160 of FIG. 1).

According to an embodiment, in operation 809, the external electronic device 300 may change the audio output mode to the ambient sound listening mode.

According to an embodiment, the external electronic device 300 may mix and output a sound acquired from the microphone 340 and audio data received from the electronic device 101 according to the ambient sound listening mode. For example, the external electronic device 300 may mix the sound acquired from the microphone 340 and the audio signal converted from the audio data, and may output the resultant data through the speaker 350.

According to an embodiment, in operation 811, the external electronic device 300 may detect a user's voice utterance using an acceleration sensor and/or the microphone 340 of a sensor (e.g., the sensor 360 of FIG. 3), and may change the audio output mode to the ambient sound listening mode or maintain the ambient sound listening mode when the voice utterance is detected.

According to an embodiment, in operation 813, when the wearer's utterance is not detected, the external electronic device 300 may start the operation of a delay timer. For example, by operating the delay timer, the electronic device 300 may maintain the ambient sound listening mode for a predetermined period of time even when the wearer's utterance is not detected, and may terminate the ambient sound listening mode when the wearer's utterance is not continuously detected for a predetermined period of time.

According to an embodiment, the external electronic device 300 may operate a timer at a point in time when the audio output mode is changed to the ambient sound listening mode and/or at a time point when it is determined to change the audio output mode to the ambient sound listening mode or maintain the ambient sound listening mode according to the wearer's utterance, or may operate the timer at a time point when the user's utterance is last detected to maintain the ambient sound listening mode for at least a predetermined period of time. For example, the timer for maintaining the ambient sound listening mode may be configured as time required to maintain the activation of the at least one application and/or component in which a user's utterance can be expected, a user's recognition is requested, or a user's response is required.

According to an embodiment, in operation 839, the electronic device 101 may determine whether a condition for terminating the ambient sound listening mode as the audio output mode of the external electronic device 300 is satisfied, and may transmit a command for terminating an ambient sound listening mode to the external electronic device 300 in operation 841 when the condition is satisfied.

According to an embodiment, a condition for terminating the ambient sound listening mode of the external electronic device 300 may include various cases in which an activation condition of at least one application and/or component in which the wearer's utterance can be expected, the wearer's recognition is requested, or the wearer's response is required is satisfied. For example, the condition for terminating the ambient sound listening mode may include termination of use of a near field communication (NFC) tag and/or a magnetic secure transmission (MST) tag application requiring tagging and confirmation thereof. For example, the condition for terminating the ambient sound listening mode may include a case in which payment is completed according to an application for simple payment authentication that requires user's fingerprint recognition and/or password authentication. For example, the condition for terminating the ambient sound listening mode may include a case in which a recording application and/or a photographing application requiring user's recognition or response is terminated.

According to an embodiment, in operation 815, the external electronic device 300 may determine whether the timer expires or the command for terminating the ambient sound listening mode is received from the electronic device 101.

According to an embodiment, when the timer expires or the command for terminating the ambient sound listening mode is received, the external electronic device 300 may return to the previous mode (e.g., the ambient sound listening mode) in operation 817, and may notify the electronic device 101 of the return in operation 819 when the ambient sound listening mode is terminated.

According to an embodiment, the electronic device 101 may display information on the change in the operation mode and/or the current operation mode of the external electronic device 300 on the display in operation 843.

According to an example embodiment, an electronic device (e.g., the electronic device 101 of FIG. 1) may include: a memory (e.g., the memory 130 of FIG. 1 or 2), a communication module comprising communication circuitry (e.g., the communication module 190 of FIG. 1) configured to communicate with an external electronic device (e.g., the external electronic device 210, 220, and/or 330 of FIG. 2 or 3), and a processor operatively connected to the memory and the communication module, wherein the processor may be configured to: confirm that the external electronic device is in a worn state through the communication module, and transmit a control command through the communication module to change an audio output mode of the external electronic device based on an operating state of the electronic device being changed according to an instruction stored in the memory so that a designated condition is satisfied, to thereby control the operation of the external electronic device according to the designated condition.

According to an example embodiment, the processor may be configured to control the communication module to assign a priority to resource allocation for transmitting the control command for changing the audio output mode of the external electronic device.

According to an example embodiment, the audio output mode may include an ambient sound listening mode in which an ambient sound is introduced through a speaker of the external electronic device and an ambient sound canceling mode in which the ambient sound is canceled.

According to an example embodiment, the designated condition may include execution or termination of at least one application executed by the processor based on an instruction stored in the memory.

According to an example embodiment, the at least one application may include at least one of applications configured to notify of the execution of the at least one application and request a response thereto.

According to an example embodiment, based on the at least one application being executed based on the instruction stored in the memory according to the designated condition, the processor may be configured to: transmit, to the external electronic device, a control command for changing the audio output mode to an ambient sound listening mode in which an ambient sound of the external electronic device is output through a speaker of the external electronic device.

According to an example embodiment, based on the at least one executed application being terminated based on the audio output mode of the external electronic device being changed to the ambient sound listening mode according to the transmission of the control command, the processor may be configured to: transmit the control command for terminating the ambient sound listening mode to the external electronic device.

According to an example embodiment, the at least one application may include at least one of a payment application, a voice recording application, and an image capturing application.

According to an example embodiment, the electronic device may further include a display, wherein the processor may be configured to provide a setting screen for configuring the designated condition through the display, and the setting screen may include an application list to allow each of at least one application to be included in the designated condition.

According to an example embodiment, the processor may be configured to provide a menu for configuring the volume of the audio signal and the volume of the ambient sound according to the audio output mode of the external electronic device through the display.

According to an example embodiment, a method of operating an electronic device (e.g., the electronic device 1 of FIG. 1) may include: confirming that an external electronic device (e.g., the external electronic device 210, 220, and/or 300 of FIG. 2 or 3) is in a worn state, determining whether a designated condition is satisfied according to a change in an operating state of the electronic device, and transmitting a control command to change an audio output mode of the external electronic device based on the designated condition being satisfied and monitoring the operation of the external electronic device.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a memory;
a communication module comprising communication circuitry configured to communicate with an external electronic device; and
a processor operatively connected to the memory and the communication module,
wherein the processor is configured to:
confirm that the external electronic device is in a worn state through the communication module; and
transmit a control command through the communication module to change an audio output mode of the external electronic device based on an operating state of the electronic device being changed according to an instruction stored in the memory so that a designated condition is satisfied, to thereby control the operation of the external electronic device according to the designated condition.

2. The electronic device of claim 1, wherein the processor is configured to control the communication module to assign a priority to resource allocation for transmitting the control command for changing the audio output mode of the external electronic device.

3. The electronic device of claim 1, wherein the audio output mode includes an ambient sound listening mode in which an ambient sound is introduced through a speaker of the external electronic device and an ambient sound canceling mode in which the ambient sound is canceled.

4. The electronic device of claim 1, wherein the designated condition includes execution or termination of at least one application executed by the processor based on an instruction stored in the memory.

5. The electronic device of claim 4, wherein the at least one application includes at least one of applications configured to notify a user of the execution of the at least one application and request a response thereto.

6. The electronic device of claim 4, wherein, based on the at least one application being executed based on the instruction stored in the memory according to the designated condition, the processor is configured to: control the communication module to transmit, to the external electronic device, a control command for changing the audio output mode to an ambient sound listening mode wherein an ambient sound of the external electronic device is output through a speaker of the external electronic device.

7. The electronic device of claim 6, wherein, based on the at least one executed application being terminated based on the audio output mode of the external electronic device being changed to the ambient sound listening mode according to the transmission of the control command, the processor is configured to: control the communication module to transmit the control command for terminating the ambient sound listening mode to the external electronic device.

8. The electronic device of claim 4, wherein the at least one application includes at least one of a payment application, a voice recording application, and an image capturing application.

9. The electronic device of claim 1, further comprising:
a display,
wherein the processor is configured to provide a setting screen for configuring the designated condition through the display, wherein the setting screen may include an application list for allowing each of at least one application to be included in the designated condition.

10. The electronic device of claim 9, wherein the processor is configured to provide a menu for configuring the volume of the audio signal and the volume of the ambient sound according to the audio output mode of the external electronic device through the display.

11. A method of operating an electronic device, the method comprising:
confirming that an external electronic device is in a worn state;
determining whether a designated condition is satisfied according to a change in an operating state of the electronic device; and
transmitting a control command to change an audio output mode of the external electronic device based on the designated condition being satisfied and monitoring the operation of the external electronic device.

12. The method of claim 11, further comprising assigning a priority to resource allocation for transmitting the control command for changing the audio output mode of the external electronic device.

13. The method of claim 11, wherein the audio output mode includes an ambient sound listening mode in which an ambient sound is introduced through a speaker of the external electronic device and an ambient sound canceling mode in which the ambient sound is canceled.

14. The method of claim 11, wherein the designated condition includes execution or termination of at least one application executed based on an instruction stored in the memory of the electronic device.

15. The method of claim 14, wherein the at least one application includes at least one of applications that provide a notification of execution of the at least one application and request a response thereto.

16. The method of claim 14, further comprising transmitting, to the external electronic device, a control command for changing the audio output mode to an ambient sound listening mode wherein an ambient sound of the external electronic device is output through a speaker of the external electronic device, based on the at least one application being executed based on the instruction stored in the memory according to the designated condition.

17. The method of claim 16, further comprising: transmitting the control command for terminating the ambient sound listening mode to the external electronic device, based on the at least one executed application being terminated based on the audio output mode of the external electronic device being changed to the ambient sound listening mode according to the transmission of the control command.

18. The method of claim 14, wherein the at least one application includes at least one of a payment application, a voice recording application, and an image capturing application.

19. The method of claim 11, further comprising providing a setting screen for configuring the designated condition through the display of the electronic device,
wherein the setting screen includes an application list allowing each of at least one application to be included in the designated condition.

20. The method of claim 19, further comprising providing a menu for configuring the volume of the audio signal and the volume of the ambient sound according to the audio output mode of the external electronic device through the display.
